(19) United States
(12) Patent Application Publication
(10) Pub. No.: US 2024/0201764 A1
(43) Pub. Date: Jun. 20, 2024

(54) SYSTEM FOR LONG-DISTANCE POWER TRANSMISSION AND METHOD OF OPERATING THE SAME

(71) Applicant: BKS TEC CORP., HSINCHU CITY (TW)

(72) Inventors: CHENG HSIANG CHEN, HSINCHU CITY (TW); YIH SHYANG HER, HSINCHU CITY (TW); HSIN TSE TSAI, HSINCHU CITY (TW)

(21) Appl. No.: 18/510,054

(22) Filed: Nov. 15, 2023

Related U.S. Application Data
(60) Provisional application No. 63/433,584, filed on Dec. 19, 2022.
(60) Provisional application No. 63/510,701, filed on Jun. 28, 2023.

(51) Int. Cl. G06F 1/26

(52) U.S. Cl. CPC G06F 1/266

(57) ABSTRACT

A system and a method for data and power transmission including a receive dongle device are proposed. The receive dongle device includes: a receive handshake controller configured to determine a first voltage of a first power signal, the first power signal configured to be transmitted from a source device to a sink device; a receive input port configured to receive a second power signal having a second voltage different from the first voltage; and a receive voltage converter configured to convert the second power signal to a third power signal having the first voltage and to provide the third power signal to the sink device.

### CROSS REFERENCE TO RELATED APPLICATIONS

This application claims priority to U.S. Provisional Application No. 63/433,584 filed on Dec. 19, 2022 and U.S. Provisional Application No. 63/510,701 filed on Jun. 28, 2023, the disclosures of which are hereby incorporated by reference in their entirety.

### TECHNICAL FIELD

The present disclosure relates to a power transmission system and a method of operating the system. Particularly, the present disclosure relates to a USB dongle device for long-distance power transmission and a method of long-distance power transmission using the USB dongle device.

### DISCUSSION OF THE BACKGROUND

Universal Serial Bus (USB) is a popular industry standard used to provide a unified interface for connecting a personal computer to peripheral devices, such as a keyboard, a mouse, a portable memory device, a mobile phone, a wireless modem, a hub, etc., and providing power from the personal computer to such peripheral devices. The USB standard defines a connector specification that specifies dimensions and functions of connectors, and establishes transmission protocols with accompanying electrical properties for delivering data and power between the USB-connected devices.

As the applications and functionalities of the USB-compatible devices have increased rapidly, a need for an improved power-delivery capability, for delivery of greater levels of power to the USB-compatible devices, has emerged. Of particular urgency are applications in which power is supplied over a greater distance using a USB-compatible device, since power loss and voltage drop become noticeable after the power is transmitted over a power line of greater length, e.g., in a range of about 10 meters to about 100 meters. Therefore, there is a need to develop an improved structure and method for effectively increasing an applicable power-delivery length of the power line while maintaining compliance with the USB standard.

This Discussion of the Background section is provided for background information only. The statements in this Discussion of the Background are not an admission that the subject matter disclosed in this Discussion of the Background section constitute prior art to the present disclosure, and no part of this Discussion of the Background section may be used as an admission that any part of this application, including this Discussion of the Background section, constitutes prior art to the present disclosure.

### SUMMARY

One aspect of the present disclosure relates to a system for data and power transmission, including a receive dongle device. The receive dongle device includes: a receive handshake controller configured to determine a first voltage of a first power signal, the first power signal configured to be transmitted from a source device to a sink device; a receive input port configured to receive a second power signal having a second voltage different from the first voltage; and a receive voltage converter configured to convert the second power signal to a third power signal having the first voltage and to provide the third power signal to the sink device.

In accordance with some embodiments of the present disclosure, the system further comprises a power line connected between the source device and the sink device, wherein the sink device is configured to transmit the second power signal.

In accordance with some embodiments of the present disclosure, the system further includes a transmit dongle device, including: a transmit input port configured to receive the first power signal from the source device; a transmit handshake controller configured to operate with the receive handshake controller to determine the second voltage; and a transmission voltage converter configured to convert the first power signal to the second power signal having a third voltage.

In accordance with some embodiments of the present disclosure, the second voltage is greater than the first voltage.

In accordance with some embodiments of the present disclosure, the third voltage is greater than the second voltage.

In accordance with some embodiments of the present disclosure, the system further includes a transmission line assembly connected between the transmit dongle device and the receive dongle device, wherein the power line is included in the transmission line assembly.

In accordance with some embodiments of the present disclosure, the transmission line assembly further comprises a signal line configured to transmit a first data signal.

In accordance with some embodiments of the present disclosure, the first data signal is an optical signal.

In accordance with some embodiments of the present disclosure, the system further includes a memory device configured to store a current limit of the power line, wherein the receive handshake controller is configured to determine whether power delivery between the source device and the sink device is authorized based on the current limit.

In accordance with some embodiments of the present disclosure, the second voltage is less than the first voltage.

Another aspect of the present disclosure relates to a method, which includes: performing a handshake operation between a source device and a sink device to determine a first voltage; detecting, in response to power being received from a power line, a first power signal having a second voltage; converting the first power signal to a second power signal having the first voltage; and providing the second power signal to the sink device.

In accordance with some embodiments of the present disclosure, the first voltage is less than the second voltage.

In accordance with some embodiments of the present disclosure, the method further includes: performing the handshake operation further to determine a third voltage different from the first voltage; providing a third power signal having the first voltage by the source device; converting the third power signal to a fourth power signal having the third voltage; and transmitting the fourth power signal to the power line.

In accordance with some embodiments of the present disclosure, the performing of the handshake operation to determine the third voltage comprises performing the handshake operation between a transmit handshake controller and a receive handshake controller arranged at a first end and a second end, respectively, of the power line.

In accordance with some embodiments of the present disclosure, the converting of the third power signal to the fourth power signal is performed based on information of a maximal current limit and a resistance associated with the power line.

In accordance with some embodiments of the present disclosure, the method further includes receiving the information of the maximal current limit and the resistance associated with the power line from a marker device.

In accordance with some embodiments of the present disclosure, the method further includes terminating a connection between the source device and the sink device in response to determining that a maximal power loss is greater than a power difference between a first power level supported by the source device and a second power level requested by the sink device.

In accordance with some embodiments of the present disclosure, the detecting of the first power signal further comprises detecting a first data signal through a signal line.

In accordance with some embodiments of the present disclosure, the first data signal is an optical signal.

In accordance with some embodiments of the present disclosure, the converting of the first power signal to the second power signal is performed based on a look-up table of support voltages, including the first voltage, of the power line.

By incorporating the transmit handshake controller or the receive handshake controller, an effective transmission voltage of the power signal can increased when the power signal is transmitted via the power line to reduce an effective power loss given a constant power constraint of the power signal. As a result, the reduced effective power loss can aid in long-distance delivery of power to USB-connected devices. In addition, a charging capability based on power delivery to the USB-compatible devices can be improved.

The foregoing has outlined rather broadly the features and technical advantages of the present disclosure in order that the detailed description of the disclosure that follows may be better understood. Additional features and technical advantages of the disclosure are described hereinafter, and form the subject of the claims of the disclosure. It should be appreciated by those skilled in the art that the concepts and specific embodiments disclosed may be utilized as a basis for modifying or designing other structures, or processes, for carrying out the purposes of the present disclosure. It should also be realized by those skilled in the art that such equivalent constructions do not depart from the spirit or scope of the disclosure as set forth in the appended claims.

### BRIEF DESCRIPTION OF THE DRAWINGS

A more complete understanding of the present disclosure may be derived by referring to the detailed description and claims. The disclosure should also be understood to be coupled to the figures' reference numbers, which refer to similar elements throughout the description.

FIG. 1 is a schematic block diagram of a USB transmission system, in accordance with some embodiments of the present disclosure.

FIGS. 2A and 2B are schematic block diagrams of a transmit dongle device and a receive dongle device, respectively, of the USB transmission system shown in FIG. 1, in accordance with some embodiments of the present disclosure.

FIG. 3 is a schematic block diagram of the USB transmission system shown in FIG. 1 in greater detail, in accordance with some embodiments of the present disclosure.

FIG. 4 is a schematic block diagram of a receive dongle device and a transmission line assembly of the USB transmission system shown in FIG. 1, in accordance with some embodiments of the present disclosure.

FIG. 5 shows a schematic flowchart of a method of operating a USB transmission system, in accordance with some embodiments of the present disclosure.

FIG. 6 shows a schematic flowchart of a method of operating a USB transmission system, in accordance with some embodiments of the present disclosure.

### DETAILED DESCRIPTION

Embodiments, or examples, of the disclosure illustrated in the drawings are now described using specific language. It shall be understood that no limitation of the scope of the disclosure is hereby intended. Any alteration or modification of the described embodiments, and any further applications of principles described in this document, are to be considered as normally occurring to one of ordinary skill in the art to which the disclosure relates. Reference numerals may be repeated throughout the embodiments, but this does not necessarily mean that feature(s) of one embodiment apply to another embodiment, even if they share the same reference numeral.

It shall be understood that, although the terms first, second, third, etc. may be used herein to describe various elements, components, regions, layers or sections, these elements, components, regions, layers or sections are not limited by these terms. Rather, these terms are merely used to distinguish one element, component, region, layer or section from another element, component, region, layer or section. Thus, a first element, component, region, layer or section discussed below could be termed a second element, component, region, layer or section without departing from the teachings of the present inventive concept.

The terminology used herein is for the purpose of describing particular example embodiments only and is not intended to be limiting to the present inventive concept. As used herein, the singular forms “a,” “an” and “the” are intended to include the plural forms as well, unless the context clearly indicates otherwise. It shall be understood that the terms “comprises” and “comprising,” when used in this specification, point out the presence of stated features, integers, steps, operations, elements, or components, but do not preclude the presence or addition of one or more other features, integers, steps, operations, elements, components, or groups thereof.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

Notwithstanding that the numerical ranges and parameters setting forth the broad scope of the disclosure are approximations, the numerical values set forth in the specific examples are reported as precisely as possible. Any numerical value, however, inherently contains certain errors necessarily resulting from the deviation normally found in the respective testing measurements. Also, as used herein, the terms “about,” “substantial” or “substantially” generally mean within 10%, 5%, 1% or 0.5% of a given value or range. Alternatively, the terms “about,” “substantial” or “substantially” mean within an acceptable standard error of the mean when considered by one of ordinary skill in the art. Other than in the operating/working examples, or unless otherwise expressly specified, all of the numerical ranges, amounts, values and percentages such as those for quantities of materials, durations of time, temperatures, operating conditions, ratios of amounts, and the likes thereof disclosed herein should be understood as modified in all instances by the terms “about,” “substantial” or “substantially.” Accordingly, unless indicated to the contrary, the numerical parameters set forth in the present disclosure and attached claims are approximations that can vary as desired. At the very least, each numerical parameter should at least be construed in light of the number of reported significant digits and by applying ordinary rounding techniques. Ranges can be expressed herein as being from one endpoint to another endpoint or between two endpoints. All ranges disclosed herein are inclusive of the endpoints, unless specified otherwise.

The terms “couple” or “connect” used throughout the present disclosure refers to physical or electrical linkage between two or more objects. These objects may also be referred to as being “coupled” or “connected” through exchange of data or information. These “coupled” or “connected” objects may be in direct contact in some cases or indirect contact through other intervening objects.

Embodiments of the present disclosure discuss structures and methods of providing power (i.e., power delivery) through a long cable, in which a length of the long cable is in a range of more than about 10 meters, more than about 50 meters or even more than about 100 meters. Existing cables used for connecting two USB-compatible devices may include a standalone power line configured to deliver power and a signal line configured to transmit high-speed data. Since the power line is generally made of conductive materials, such as copper, an internal resistance of the conductive material may incur an amount of power loss or voltage drop when the power signal is transmitted along the power line. As far as a short-cable application of USB power delivery is concerned, e.g., a source device and a sink device connected by a cable having a length less than about 3 meters or less than about 10 meters, the power loss or the voltage drop of the power cable may meet the specification of the USB standard, e.g., a voltage drop of 0.75 volts. However, when the cable length is required to exceed popular cable lengths, e.g., greater than about 10 meters, the power loss or the voltage drop may easily rise above the 0.75-volt specification.

To address the abovementioned issues, a novel transmit dongle device is proposed, wherein the transmit dongle device is arranged between a source device and a power line. In addition, a receive dongle device is proposed, wherein the receive dongle device is arranged between a sink device and the power line. In some embodiments, only the receive dongle device is present. The transmit dongle device is equipped with a transmit handshake controller (sometimes referred to as a transmit power-delivery (PD) controller), while the receive dongle device is equipped with a receive handshake controller (sometimes referred to as a receive PD controller), to cooperatively determine a transmission voltage transmitted via the power line, wherein the transmission voltage is greater than a support voltage determined by the source device and the sink device. When power is transmitted from the source device to the sink device through the power line, the support voltage is increased to the transmission voltage through voltage boosting at the transmit dongle device, and the received transmission voltage is converted to the support voltage at the receive dongle device after the power is transmitted via the power line. Therefore, power loss due to resistance of the power line can be reduced since the power line resistance is kept unchanged and a transmission current is reduced during transmission of the power through the power line. Therefore, a given amount of power can be transmitted over a greater distance with reduced transmission loss through help of the transmit dongle and receive dongle devices. The power delivery function can be applied to applications including greater transmission distances.

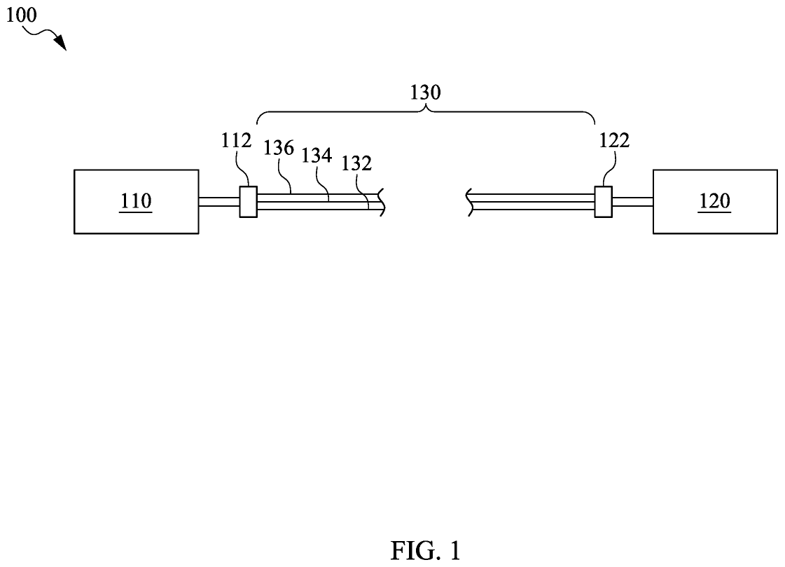

FIG. 1 is a schematic block diagram of a USB transmission system 100, in accordance with some embodiments of the present disclosure. In accordance with some embodiments of the present disclosure, the USB transmission system 100 is compliant with the USB Type-C (USB-C) standard. The USB transmission system 100 may include an exemplary source device 110, an exemplary sink device 120, a transmit dongle device 112, a receive dongle device 122, and a transmission line assembly 130. Throughout the present disclosure, the source device 110 refers to a USB-C compatible device configured to transmit data and power through the transmission line assembly 130. The data may include audio, video, control data and any other types of data. Power may be arranged in a direct current (DC) form. Data and power may be delivered from the source device 110 to the sink device 120, wherein throughout the present disclosure the sink device 120 refers to a USB-C compatible device configured to receive data and power through the transmission line assembly 130. In accordance with some embodiments of the present disclosure, the source device 110 is a camera, a monitor, or the like. In accordance with some embodiments of the present disclosure, the sink device 120 is a personal computer, a notebook computer, a docking station, or the like. The USB transmission system 100 is configured to achieve power and data delivery from the source device 110 to the sink device 120. In some embodiments of the present disclosure, the roles of the source device 110 to the sink device 120 are exchanged.

In accordance with some embodiments of the present disclosure, the transmission line assembly 130 includes a first data line 132, a second data line 134 and a power line 136 arranged parallel to each other or bundled together. The first data line 132 may be an optical cable, an active optical cable, or the like, and is configured to transmit image/video signals and USB 3.x-compatible data from the source device 110 to the sink device 120 in an optical signal format with a transmission speed of about 10 Gbps or above. The second data line 134 may be formed of a conductive material, e.g., copper, and is configured to transmit data in a USB 2.0 format from the source device 110 to the sink device 120 with a transmission speed of about 480 Mbps. Additionally, the power line 136 may be formed of a conductive material, e.g., copper, and is configured to transmit power for powering the sink device 120.

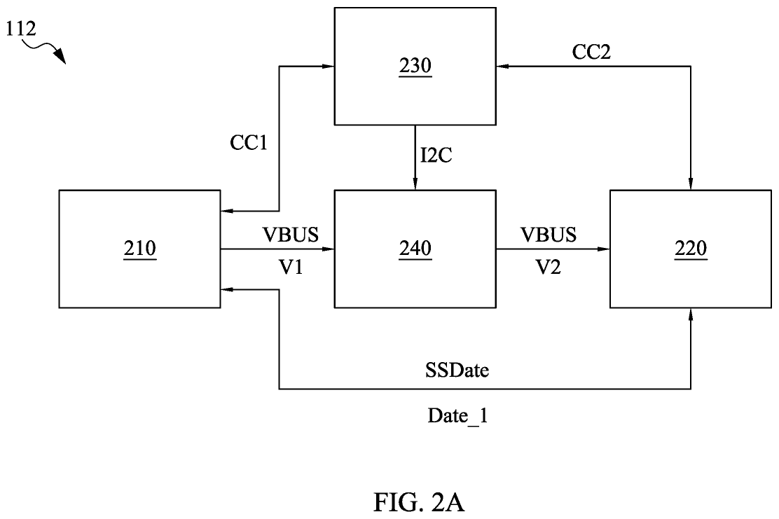

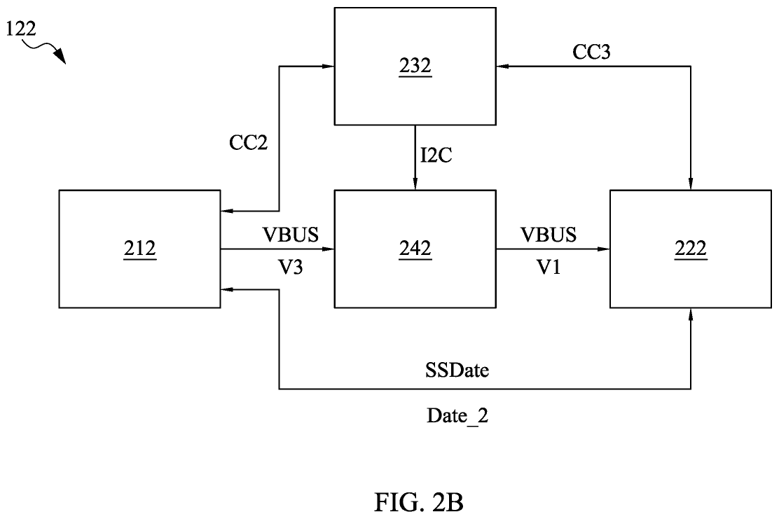

The transmit dongle device 112 is arranged between the source device 110 and the transmission line assembly 130. The receive dongle device 122 is arranged between the transmission line assembly 130 and the sink device 120. The transmit dongle device 112 and the receive dongle device 122 may also be referred to herein as the transmitter 112 and the receiver 122, respectively, and are described in greater detail below with reference to FIGS. 2A and 2B.

FIGS. 2A and 2B are schematic block diagrams of a transmit dongle device 112 and a receive dongle device 122, respectively, of the USB transmission system 100 shown in FIG. 1, in accordance with some embodiments of the present disclosure. Referring to FIG. 2A, the transmit dongle device 112 includes a transmit input port 210, a transmit output port 220, a transmit handshake controller 230 and a transmission voltage converter 240. In some embodiments of the present disclosure, some components of the transmit dongle device 112 can be omitted, and other components can be added to the transmit dongle device 112.

In accordance with some embodiments of the present disclosure, the transmit input port 210 is coupled to the source device 110. The transmit input port 210 may be a USB-C port (i.e., either a Type-C plug or a Type-C receptacle, depending upon the type of the corresponding port in the source device 110). Similarly, the transmit output port 220 may be a USB-C port (i.e., either a Type-C plug or a Type-C receptacle, depending upon the type of the corresponding port on the transmission line assembly 130). In some embodiments of the present disclosure, the transmit input port 210 is configured to receive at least one of a display port (DP)-compatible image/video signal, a USB 3.x-compatible signal, a USB 2.0-compatible signal, and a power signal. In some embodiments of the present disclosure, the transmit input port 210 is configured to provide or receive a look-up table of support voltages V1 of the source device 110. For example, the look-up table of support voltages V1 may list support voltage options of 1.5V, 3.0V, 5.0V, 9V, 12.0V, 15.0V, and 20.0V.

In accordance with some embodiments of the present disclosure, the transmit handshake controller 230 is configured to perform handshake operations with a receive handshake controller 232 (not shown in FIG. 2A, but illustrated in FIG. 2B) to determine a power signal with an initial transmission voltage V2 that can be transmitted via the power line 136. The transmit handshake controller 230 may maintain or receive a look-up table of the initial transmission voltages V2 that are selectable during the handshake process. For example, the look-up table of the initial transmission voltages V2 may list the voltage options of 5.0V, 10.0V, 20.0V and 40.0V. The initial transmission voltage V2 may be determined based on the selected support voltage V1. In some embodiments, the initial transmission voltage V2 is fixed, e.g., 40.0 V, and is greater than all of the selectable support voltages V1. In some embodiments of the present disclosure, the initial transmission voltage V2 is a fixed value and is stored in the transmit handshake controller 230.

In accordance with some embodiments of the present disclosure, the transmission voltage converter 240 is configured to convert the support voltage V1 to the initial transmission voltage V2 in accordance with an instruction of the transmit handshake controller 230. In some embodiments of the present disclosure, the initial transmission voltage V2 is greater than the support voltage V1 so as to reduce power loss during transmission of power via the power line 136 given that the resistance of the power line is kept unchanged. The transmission voltage converter 240 may be a voltage boost converter, and any type of boost converter suitable to increase the support voltage V1 to the initial transmission voltage V2 is within the contemplated scope of the present disclosure.

In accordance with some embodiments of the present disclosure, the transmit handshake controller 230 is configured to communicate information of the support voltage V1 to the source device 110 through a configuration channel CC1. Similarly, in some embodiments of the present disclosure, the transmit handshake controller 230 is configured to communicate information of the initial transmission voltage V2 to the transmit output port 220 through a configuration channel CC2. In some embodiments of the present disclosure, the transmit handshake controller 230 is configured to communicate information of the support voltage V1 and the initial transmission voltage V2 to the transmit voltage converter 240 through a control channel, e.g., an inter-integrated circuit (I²C) channel.

In accordance with some embodiments of the present disclosure, the transmit voltage converter 240 is configured to receive a power signal having the support voltage V1 from the source device 110 through a power channel VBUS. Similarly, in some embodiments of the present disclosure, the transmit voltage converter 240 is configured to provide another power signal having the initial transmission voltage V2 to the transmit output port 220 through the power channel VBUS.

In accordance with some embodiments of the present disclosure, the transmit input port 210 is configured to transmit a data signal Data_1 containing, e.g., image/video data or USB 3.x data from the source device 210 to the transmit output port 220, or from the transmit output port 220 to the source device 210, through a data line SSdata corresponding to the data line 132 shown in FIG. 1.

FIG. 2B is a schematic block diagram of the receive dongle device 122 of the USB transmission system 100 shown in FIG. 1, in accordance with some embodiments of the present disclosure. Referring to FIG. 2B, the receive dongle device 122 includes a receive input port 212, a receive output port 222, a receive handshake controller 232 and a receive voltage converter 242. In some embodiments of the present disclosure, some components of the receive dongle device 122 can be omitted, and other components can be added to the receive dongle device 122.

In accordance with some embodiments of the present disclosure, the receive input port 220 is coupled to the transmission line assembly 130. The receive input port 220 may be a USB-C port (i.e., either a Type-C plug or a Type-C receptacle, depending upon the type of corresponding port of the transmission line assembly 130). Similarly, the receive output port 222 may be a USB-C port (i.e., either a Type-C plug or a Type-C receptacle, depending upon the type of corresponding port in the sink device 120). In some embodiments of the present disclosure, the receive input port 212 is configured to receive at least one of a DP-compatible image/video signal, a USB 3.x-compatible data signal, a USB 2.0-compatible data signal, and a power signal. In some embodiments of the present disclosure, the receive output port 222 is configured to provide or receive a look-up table of support voltages V1 of the sink device 120. For example, the look-up table of support voltages V1 may list the support voltage options of 1.5V, 3.0V, 5.0V, 9.0V, 12.0V, 15.0V and 20.0V.

In accordance with some embodiments of the present disclosure, the receive handshake controller 232 is configured to perform handshake operations with the transmit handshake controller 230 shown in FIG. 2A to determine a power signal having an initial transmission voltage V2 that can be transmitted via the power line 136. The receive handshake controller 232 may maintain or receive a look-up table of initial transmission voltages V2 that are selectable during a handshake process. For example, the look-up table of the initial transmission voltages V2 may list the voltage options of 5.0V, 10.0V, 20.0V and 40.0V. In some embodiments, the initial transmission voltage V2 is fixed, e.g., 40.0 V, and is greater than all of the selectable support voltages V1. In some embodiments, the initial transmission voltage V2 is a fixed value and is stored in the receive handshake controller 232.

In accordance with some embodiments of the present disclosure, the receive voltage converter 242 is configured to convert the initial transmission voltage V2 to the support voltage V1 based on the instruction of the receive handshake controller 232. In some embodiments of the present disclosure, the initial transmission voltage V2 is greater than the support voltage V1 so as to reduce power loss during transmission of power via the power line 136. After the power signal is transmitted via the power line 136, the voltage on the power line 136 may drop from the initial transmission voltage V2 to a final transmission voltage V3. The final transmission voltage V3 may still be greater than the support voltage V1 despite the voltage drop across the power line 136. The receive voltage converter 242 may be a voltage buck converter, and any type of buck converter capable of reducing the final transmission voltage V3 to the support voltage V1 is within the contemplated scope of the present disclosure.

In some embodiments of the present disclosure, the power signal transmitted from the source device 110 and having the support voltage V1 is not boosted by the transmit voltage controller 240. As a result, the initial transmission voltage V2 is substantially equal to the support voltage V1, and the final transmission voltage V3 is less than the support voltage V1 after the power signal is transmitted via the power line 136. In such embodiments, the receive voltage converter 242 is a voltage boost converter configured to increase the voltage of the power signal received by the receive handshake controller 232 from the final transmission voltage V3 to the support voltage V1. In accordance with some embodiments of the present disclosure, the receive handshake controller 232 is configured to provide instructions to the receive voltage converter 242 to perform voltage boosting from the final transmission voltage V3 to a closest support voltage V1 based on the list of support voltages V1. For example, if the receive handshake controller 232 receives a power signal having a final transmission voltage V3 of about 18V from the power line 136, the receive handshake controller 232 may instruct the receive voltage converter 242 to increase the voltage of the power signal to the closest support voltage V1, i.e., 20.0V, based on the list of the support voltages V1.

In accordance with some embodiments of the present disclosure, the receive handshake controller 232 is configured to communicate information of the initial transmission voltage V2 to the receive input port 212 through the data channel CC2. Similarly, in some embodiments, the receive handshake controller 232 is configured to communicate information of the support voltage V1 to the receive output port 222 through a configuration channel CC3. The source device 110 and the sink device 120 are configured to determine the support voltage V1 through the transmit dongle device 112 (via the transmit handshake controller 230) and the receive dongle device 122 (via the receive handshake controller 232). In accordance with some embodiments of the present disclosure, the receive handshake controller 232 is configured to communicate information of the support voltage V1 and the initial transmission voltage V2 to the receive voltage converter 242 through the control channel, e.g., an inter-integrated circuit (I²C) channel.

In accordance with some embodiments of the present disclosure, the receive voltage converter 242 is configured to receive the final transmission voltage V3 from the receive input port 212 through a power channel VBUS. Similarly, in some embodiments, the receive voltage converter 242 is configured to provide the support voltage V1 to the receive output port 222 through the power channel VBUS.

In accordance with some embodiments of the present disclosure, the receive input port 212 is configured to transmit a data signal Data_2 containing, e.g., image/video data or USB 3.x data from the transmission line assembly 130 to the receive output port 222, or from the receive output port 222 to the transmission line assembly 130, through a data line SSdata corresponding to the data line 132 shown in FIG. 1.

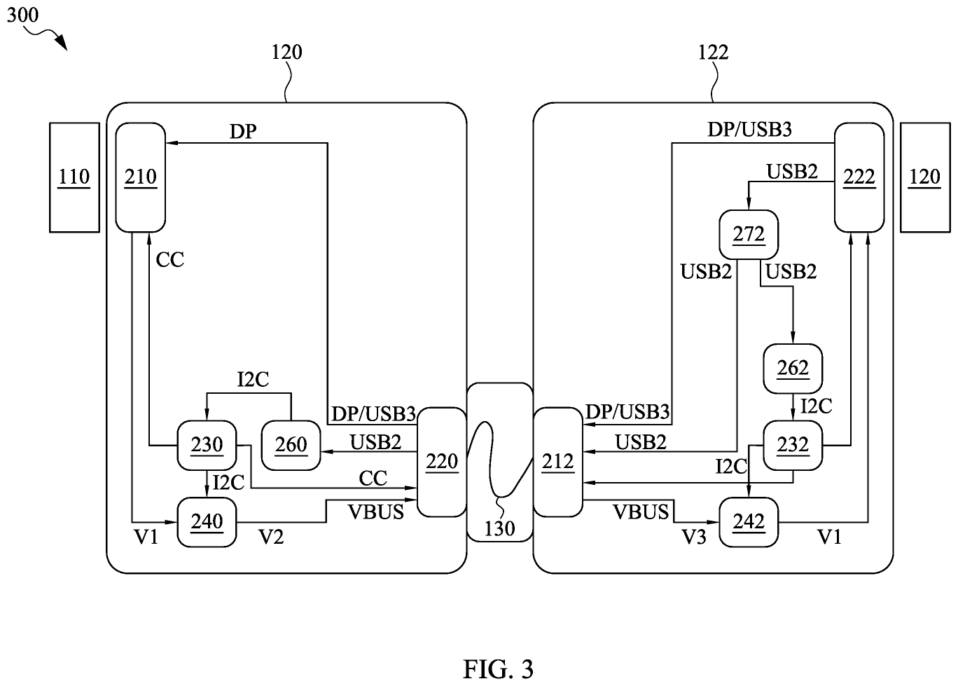

FIG. 3 is a schematic block diagram 300 of the USB transmission system 100 shown in FIG. 1 in greater detail, in accordance with some embodiments of the present disclosure. In some embodiments of the present disclosure, the USB transmission system 100 shown in FIG. 3 includes the source device 110, the sink device 120, the transmit dongle device 112, the receive dongle device 122, and the transmission line assembly 130.

The transmit dongle device 112 may include the transmit input port 210, the transmit output port 220, the transmit handshake controller 230 and the transmit voltage converter 240. Such elements have been discussed above with reference to FIG. 2A, and descriptions of similar features are not repeated for brevity. Referring to FIGS. 2A and 3, the transmit dongle device 112 shown in FIG. 3 further includes a transmit billboard controller 260 coupled to the transmit output port 220 and the transmit handshake controller 230. The transmit billboard controller 260 may be coupled to the transmit output port 220 and the transmit handshake controller 230 through a USB 2.0 control channel and an I²C control channel, respectively. The transmit billboard controller 260 may be used to notify the transmit output port 220 or the transmit handshake controller 230 of functions supported by the transmission line assembly 130.

The receive dongle device 122 may include the receive input port 212, the receive output port 222, the receive handshake controller 232 and the receive voltage converter 242. Such elements have been discussed above with reference to FIG. 2B, and descriptions of similar features are not repeated for brevity. Referring to FIGS. 2B and 3, the receive dongle device 122 shown in FIG. 3 further includes a receive billboard controller 262 coupled to the receive output port 222 and the receive handshake controller 232. The receive billboard controller 262 may be coupled to the receive output port 222 and the receive handshake controller 232 through a USB 2.0 control channel and an I²C control channel, respectively. The receive billboard controller 262 may be used to notify the receive output port 222 or the receive handshake controller 232 of the functions supported by the transmission line assembly 130.

Moreover, the receive dongle device 122 shown in FIG. 3 further includes a hub controller 272 coupled to the receive output port 222, the receive billboard controller 262 and the receive input port 212. The hub controller 272 may be coupled to the receive output port 222, the receive billboard controller 262 and the receive input port 212 through a USB 2.0 control channel. The hub controller 272 may be used to perform control functions when the sink device 120, such as a notebook, is configured as a host device. In such case, the remaining circuits or devices of the receive dongle device 122 can be monitored, controlled, or configured through the hub controller 272.

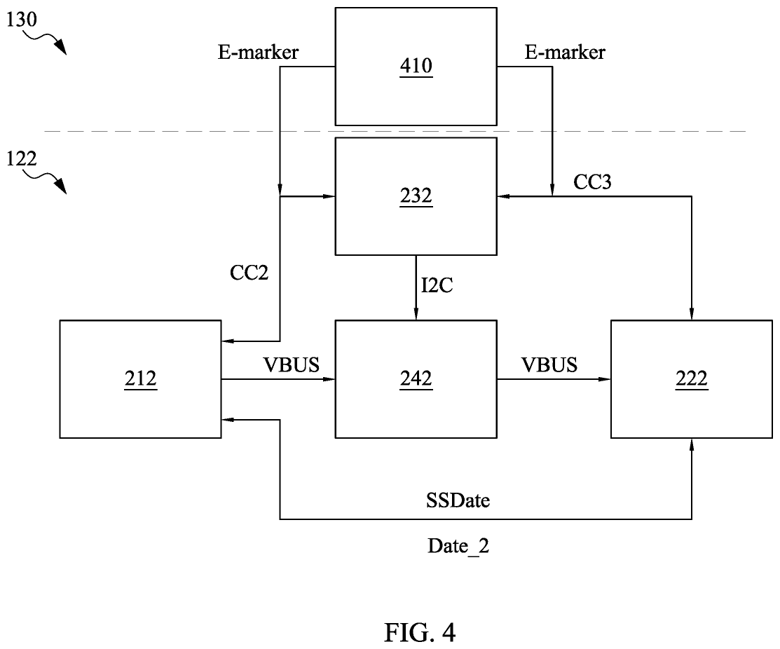

FIG. 4 is a schematic block diagram of the receive dongle device 122 and the transmission line assembly 130, in accordance with some embodiments of the present disclosure. Referring to FIG. 4, the transmission line assembly 130 further includes a marker device 410 (E-marker) configured to store information (parameters) associated with the power line 136, e.g., the manufacturer, the specification of the transmission line assembly 130, an upper current limit of the power line 136, etc. The marker device 410 may be implemented as a non-volatile memory, e.g., ROM, flash memory, or the like. In some embodiments of the present disclosure, the marker device 410 may be embedded in a structure of the transmission line assembly 130, and is accessible by the source device 110, the sink device 120, the transmit dongle device 112 and the receive dongle device 122 through electrical connection via the configuration channel CC2 or CC3.

In accordance with some embodiments of the present disclosure, during operation, when the information of the marker device 410 is accessed by the receive dongle device 122, the receive dongle device 122 will obtain the upper current limit associated with the power line 136. Further, a parameter of an internal resistance value of the power line 136 may also be stored in the marker device 410 and accessed by the receive dongle device 122. As a result, the receive dongle device 122 can derive a maximal voltage drop of the power line 136 based on the transmission current, which is generally set at the upper current limit, and the resistance value of the power line 136. The receive voltage converter 242 can thus be configured to compensate for the voltage drop caused by the power line 136 by converting a power signal having the final transmission voltage V3, received by the receive input port 212, to the output power signal having the support voltage V1. In such case, where the E-marker information is leveraged, the support voltage V1 of the input power signal at the source device 110 does not need to be increased to a higher initial transmission voltage V2 and then returned to the support voltage V1 after the power is transmitted through the power line 136. Rather, in such cases, the power signal having the initial transmission voltage V2 is substantially equal to the support voltage V1, and the power signal is transmitted via the power line 136. As a result, the power signal may, after being transmitted via the power line 136, have the final transmission voltage V3 less than the support voltage V1 due to the voltage boosting operation not having been performed in the transmit dongle device 112.

In accordance with some embodiments of the present disclosure, during operation, when the parameters associated with the power line 136 stored in the marker device 410 are not accessible, the receive dongle device 122 can still try to determine the most likely support voltage V1 based on the list of the support voltages V1 in the look-up table of support voltages V1. For example, the receive handshake controller 232 or any other controller of the receive dongle device 122 can derive a closest candidate support voltage V1 by comparing the final transmission voltage V3 to the list of support voltages V1 in the look-up table of support voltages V1. In such case, the final transmission voltage V3 may be less than the support voltage V1 due to the voltage boosting operation not being performed in the transmit dongle device 112.

In accordance with some embodiments of the present disclosure, given the parameters of the maximal current limit and the resistance of the power line 136, the maximal power loss caused by the power line 136 can be estimated. If the estimated maximal power loss or voltage drop is substantially equal to or less than a power margin (power difference) between the maximal power level of the source device 110 and the power level requested by the sink device 120, the source device 110 can compensate for the maximal power loss of the power line 136 without compromising the voltage level of the power signal. The request of power delivery from the source device to the sink device is authorized and executed.

In contrast, in accordance with other embodiments of the present disclosure, if the estimated maximal power loss caused by the power line 136 is greater than the power difference that the source device 110 can compensate for, it may be difficult or impossible to restore the final transmission voltage V3 to the predetermined support voltage V1, and the voltage drop caused by the power line 136 cannot meet the specification of the voltage level of the power line 136 or the USB-C standard. As a result, the receive handshake controller 232 will reject the power delivery request and terminate the power delivery connection of the power line 136 between the source device 110 and the sink device 120.

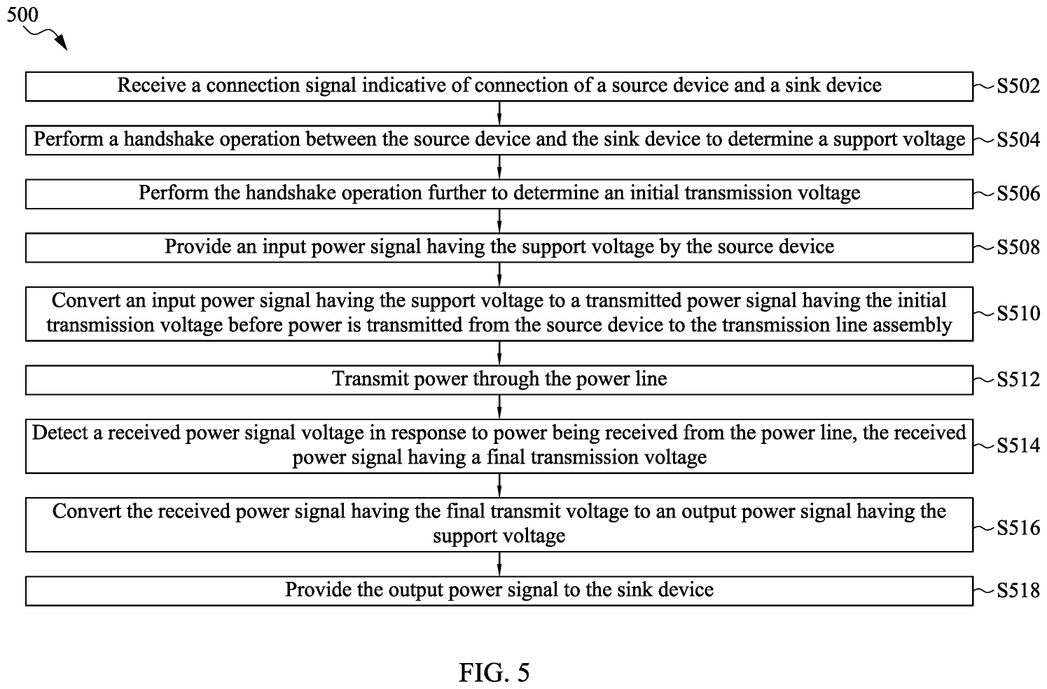

FIG. 5 shows a schematic flowchart of a method 500 of operating the USB transmission system 100, in accordance with some embodiments of the present disclosure. It should be understood that additional steps can be provided before, during, and after the steps shown in FIG. 5, and some of the steps described below can be replaced or eliminated in other embodiments of the method 500. The order of the steps may be interchangeable.

At step S502, a connection signal is received, wherein the connection signal indicates a connection between a source device and a sink device.

At step S504, a handshake operation is performed between the source device and the sink device to determine a support voltage, wherein a power signal having the support voltage is to be transmitted from the source device to the sink device. In some embodiments of the present disclosure, the support voltage is selected from a list of support voltages.

At step S506, the handshake operation is further performed to determine an initial transmission voltage. In some embodiments, the initial transmission voltage is greater than the support voltage. The initial transmission voltage may be determined through handshake operations between a transmit handshake controller coupled between the source device and a transmission line assembly, and a receive handshake controller coupled between the transmission line assembly and the sink device.

At step S508, an input power signal having the support voltage is provided by the source device.

At step S510, the input power signal is converted to a transmitted power signal having the initial transmission voltage before power is transmitted from the source device or the transmit dongle device to the transmission line assembly.

At step S512, power is transmitted through the power line. In some embodiments of the present disclosure, the power line is embedded in the transmission line assembly, wherein the transmission line assembly further includes a first data line and a second data line configured to transmit data signals.

At step S514, a received power signal is detected in response to power being received from the power line, wherein the received power signal has a final transmission voltage. In some embodiments of the present disclosure, the final transmission voltage is lower than the initial transmission voltage.

At step S516, the received power signal having the final transmission voltage is converted to an output power signal having the support voltage.

At step S518, the output power signal is provided to the sink device.

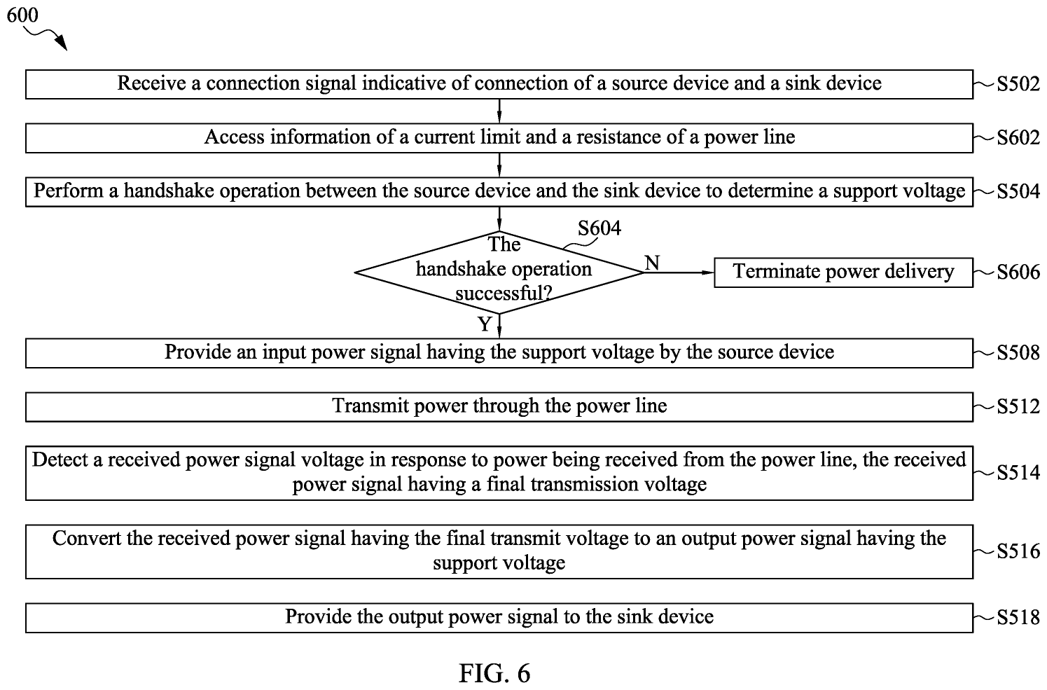

FIG. 6 shows a schematic flowchart of a method 600 of operating the USB transmission system 100, in accordance with some embodiments of the present disclosure. It should be understood that additional steps can be provided before, during, and after the steps shown in FIG. 6, and some of the steps described below can be replaced or eliminated in other embodiments of the method 600. The order of the steps may be interchangeable.

At step S502, a connection signal is received, wherein the connection signal indicates a connection between a source device and a sink device.

At step S602, information of a (maximal) current limit and a resistance of a power line is accessed. The information of the current limit may be accessed from a marker device embedded in the transmission line assembly. According to some embodiments of the present disclosure, step S602 is omitted from the method 600.

At step S504, a handshake operation is performed between the source device and the sink device to determine a support voltage, wherein a power signal having the support voltage is to be transmitted from the source device to the sink device. In some embodiments of the present disclosure, the support voltage is selected from a list of support voltages.

At step S604, it is determined whether the handshake operation is successful, i.e., it is determined that whether the determination of the support voltage is successful. In accordance with some embodiments of the present disclosure, during the handshake operation performed between the source device and the sink device, the receive handshake controller is configured to determine whether power delivery between the source device and the sink device is authorized or rejected based on the current limit and the resistance of the power line. In some embodiments, a maximal power loss of the power line is determined based on the maximal current limit and the resistance of the power line. If the maximal power loss is substantially equal to or less than a power difference between the maximal power level supported by the source device and a power level requested by the sink device, the power delivery using the support voltage is authorized. That means the handshake operation of determining the support voltage is successful. Then the method 600 proceeds with step S508.

Otherwise, in some embodiments of the present disclosure, if the maximal power loss is greater than the power difference between the maximal power level supported by the source device and the power level requested by the sink device, the request of power delivery between the source device and the sink device is rejected and the power delivery connection between the source device and the sink device is terminated, as indicated by step S606. That means the handshake operation of determining the support voltage is not successful.

In accordance with some embodiments, the function of data transmission of the USB transmission system continues working and is independent of the function of power delivery. In other words, transmission of data between the source device and the sink device is maintained and works normally regardless of the success or failure of the handshake result of determining the support voltage for power delivery.

At step S508, an input power signal having the support voltage is provided by the source device.

At step S512, power is transmitted through the power line. In some embodiments of the present disclosure, the power line is embedded in the transmission line assembly, wherein the transmission line assembly further includes a first data line and a second data line configured to transmit data signals.

At step S514, in response to power being received from the power line, a received power signal having a final transmission voltage is detected. In some embodiments of the present disclosure, the final transmission voltage is lower than the initial transmission voltage.

At step S516, the received power signal having the final transmission voltage is converted to an output power signal having the support voltage.

At step S518, the output power signal is provided to the sink device.

Although the present disclosure and its advantages have been described in detail, it should be understood that various changes, substitutions and alterations can be made herein without departing from the spirit and scope of the disclosure as defined by the appended claims. For example, many of the processes discussed above can be implemented in different methodologies and replaced by other processes, or a combination thereof.

Moreover, the scope of the present application is not intended to be limited to the particular embodiments of the process, machine, manufacture, composition of matter, means, methods and steps described in the specification. As one of ordinary skill in the art will readily appreciate from the present disclosure, processes, machines, manufacture, compositions of matter, means, methods or steps, presently existing or later to be developed, that perform substantially the same function or achieve substantially the same result as the corresponding embodiments described herein, may be utilized according to the present disclosure. Accordingly, the appended claims are intended to include within their scope such processes, machines, manufacture, compositions of matter, means, methods and steps.

What is claimed is:

1. A system for power transmission, comprising:
a receive dongle device, including:
a receive handshake controller configured to determine a first voltage of a first power signal, the first power signal configured to be transmitted from a source device to a sink device;
a receive input port configured to receive a second power signal having a second voltage different from the first voltage; and
a receive voltage converter configured to convert the second power signal to a third power signal having the first voltage and to provide the third power signal to the sink device.

2. The system of claim 1, further comprising a power line connected between the source device and the sink device, and configured to transmit the second power signal.

3. The system of claim 2, further comprising:
a transmit dongle device, including:
a transmit input port configured to receive the first power signal from the source device;
a transmit handshake controller configured operate with the receive handshake controller to determine the second voltage; and
a transmit voltage converter configured to convert the first power signal to the second power signal having a third voltage.

4. The system of claim 3, wherein the second voltage is greater than the first voltage.

5. The system of claim 4, wherein the third voltage is greater than the second voltage.

6. The system of claim 4, further comprising a transmission line assembly connected between the transmit dongle device and the receive dongle device, wherein the power line is included in the transmission line assembly.

7. The system of claim 6, wherein the transmission line assembly further comprises a signal line configured to transmit a first data signal.

8. The system of claim 7, wherein the first data signal is an optical signal.

9. The system of claim 2, further comprising a memory device configured to store a current limit of the power line, wherein the receive handshake controller is configured to determine whether power delivery between the source device and the sink device is authorized based on the current limit.

10. The system of claim 9, wherein the second voltage is less than the first voltage.

11. A method, comprising:
performing a handshake operation between a source device and a sink device to determine a first voltage;
detecting, in response to power being received from a power line, a first power signal having a second voltage;
converting the first power signal to a second power signal having the first voltage; and
providing the second power signal to the sink device.

12. The method of claim 11, wherein the first voltage is less than the second voltage.

13. The method of claim 11, further comprising:
performing the handshake operation further to determine a third voltage different from the first voltage;
providing a third power signal having the first voltage by the source device;
converting the third power signal to a fourth power signal having the third voltage; and
transmitting the fourth power signal to the power line.

14. The method of claim 13, wherein the performing of the handshake operation to determine the third voltage comprises performing the handshake operation between a transmit handshake controller and a receive handshake controller arranged at a first end and a second end, respectively, of the power line.

15. The method of claim 13, wherein the converting of the third power signal to the fourth power signal is performed based on information of a maximal current limit and a resistance associated with the power line.

16. The method of claim 15, further comprising receiving the information of the maximal current limit and the resistance associated with the power line from a marker device.

17. The method of claim 11, further comprising terminating a connection between the source device and the sink device in response to determining that a maximal power loss is greater than a power difference between a first power level supported by the source device and a second power level requested by the sink device.

18. The method of claim 11, wherein the detecting of the first power signal further comprises detecting a first data signal through a signal line.

19. The method of claim 18, wherein the first data signal is an optical signal.

20. The method of claim 11, wherein the converting of the first power signal to the second power signal is performed based on a look-up table of support voltages, including the first voltage, of the power line.
